(19) United States
(12) Patent Application Publication
(10) Pub. No.: US 2026/0175466 A1
(43) Pub. Date: Jun. 25, 2026

(54) WOOD MOLDING AND SHEET FORMING SYSTEM AND METHOD

(71) Applicant: Georgia Southern University Research and Service Foundation, Inc., Statesboro, GA (US)

(72) Inventor: Shaowen Xu, Statesboro, GA (US)

(21) Appl. No.: 19/426,903

(22) Filed: Dec. 19, 2025

Related U.S. Application Data
(60) Provisional application No. 63/737,104, filed on Dec. 20, 2024.

(51) Int. Cl. B27D 3/00; B27D 5/00; B27K 5/00

(52) U.S. Cl. CPC B27D 3/00; B27D 5/00; B27K 5/00

(57) ABSTRACT

A method may bathe a wood blank in a pretreatment liquid to reduce a lignin content of the wood blank, remove the wood blank from the pretreatment liquid, rinse the removed wood blank in fresh water, emplace the wood blank in a cavity of a die, heat and compressing the wood blank within the cavity of the die to: conform the wood blank into a shape of the cavity of the die, and densify a cellular structure of the wood blank to create a densified wood object. A method may maintain a pressure and a temperature within the cavity above a threshold pressure and a threshold temperature for a period of time within the cavity, adjust the temperature and pressure within the cavity to room temperature and pressure to dehydrate and reconsolidate the densified wood object, remove the densified wood object from the cavity of the die.

### CROSS-REFERENCE TO RELATED APPLICATIONS

This application claims the benefit of U.S. Provisional Patent Application No. 63/737,104 filed on Dec. 20, 2025, the entire contents of which are incorporated by reference herein.

### BACKGROUND

The present disclosure generally relates to wood manufacturing and wood densification. More particularly, the present disclosure relates to manufacturing densified wood products that have improved strength and can be formed into complex shapes. Example wood products can be used for wood arts, jewelry, engineering parts, daily life used parts and vehicles such as aircraft, watercraft, and unmanned aerial vehicles (UAVs).

Wood is a multi-scale structured tissue of the stems and roots of woody plants. Wood is one of the most abundant, renewable, and sustainable natural resources on earth. Wood is a natural composite of cellulose fibers embedded in matrix of lignin. Wood is often used as a construction material in furniture, handles of tools, carving arts (e.g., hand carvings), and paper, and is commonly used as a source of fuel for combustion and heat.

Plywood is a composite engineered wood product manufactured from thin layers or “plies” of wood veneer that are glued together with adjacent layers having their wood grain rotated up to 90 degrees to one another. Plywood is constructed by combining wood veneers together in order to create a flat sheet.

### SUMMARY

In some aspects, the disclosure relates to a method of manufacturing a densified wooden object, including: bathing a wood blank in a pretreatment liquid to reduce a lignin content of the wood blank; removing the wood blank from the pretreatment liquid; rinsing the removed wood blank in fresh water; emplacing the wood blank in a cavity of a die; heating and compressing the wood blank within the cavity of the die to: conform the wood blank into a shape of the cavity of the die, and densify a cellular structure of the wood blank to create a densified wood object; maintaining a pressure and a temperature within the cavity above a threshold pressure and a threshold temperature for a period of time within the cavity; adjusting the temperature and pressure within the cavity to room temperature and pressure to dehydrate and reconsolidate the densified wood object; removing the densified wood object from the cavity of the die; and providing the densified wood object.

In some aspects, the disclosure relates to a method, wherein the wood blank is one of a plurality of wood blanks formed by portioning a wood sheet, wherein the wood sheet has a first tensile strength, and wherein the tensile strength of the densified wood object is at least two times the first tensile strength.

In some aspects, the disclosure relates to a method, wherein the pretreatment liquid includes at least one of a lignin-modifying enzyme, an ionic liquid, or an organisolv.

In some aspects, the disclosure relates to a method, wherein the pretreatment liquid includes at least one of sodium hydroxide (NaOH), sodium sulfide (Na2S), sodium sulfite (Na2SO3), sodium chlorite (NaClO2), hydrogen peroxide (H2O2), sodium hypochlorite (NaOCl), and/or calcium hypochlorite (Ca(ClO)2), or a combination thereof.

In some aspects, the disclosure relates to a method, wherein the pretreatment liquid is room temperature or heated to a temperature between 50 degrees Celsius to 110 degrees Celsius.

In some aspects, the disclosure relates to a method, wherein the threshold temperature is between 100 degrees Celsius and 190 degrees Celsius, and the period of time ranges from 0.5 hours to 24 hours.

In some aspects, the disclosure relates to a method, wherein the wood object is plywood.

In some aspects, the disclosure relates to a method, wherein the densified wood object is provided for coupling to an aircraft or a watercraft, and wherein the aircraft is an unmanned aerial vehicle.

In some aspects, the disclosure relates to a method, wherein the densified wood object is a propeller or rotor.

In some aspects, the disclosure relates to a method, wherein the densified wood object is a wood art, jewelry, spoons, coaster, logo or coin.

In some aspects, the disclosure relates to a method, wherein compressing and simultaneously heating the wood blank within the cavity of the die includes applying a pressure of between 5 MPa to 60 MPa.

In some aspects, the disclosure relates to a method, wherein the threshold pressure is 5 MPa.

In some aspects, the disclosure relates to a method, wherein a tensile strength of the densified wood object is greater than 100 MPa.

In some aspects, the disclosure relates to a motorcraft including: a prime mover including an output shaft; and a propeller coupled to the output shaft and made of a densified wood manufactured by: obtaining a wood sheet having a first tensile strength; portioning the wood sheet into a plurality of wood blanks; bathing a wood blank of the plurality of wood blanks in a pretreatment liquid to reduce a lignin content of the wood blank; removing the wood blank from the pretreatment liquid; emplacing the wood blank in a cavity of a die; compressing and simultaneously heating the wood blank within the cavity of the die to: conform the wood blank into a shape of the cavity of the die, and simultaneously densify a cellular structure of the wood blank to create a densified wood object; maintaining a pressure and a temperature within the cavity above a threshold pressure and a threshold temperature for a period of time between approximately 0.5 hours to approximately 24 hours to dehydrate and reconsolidate the densified wood object within the cavity; adjusting the temperature and pressure within the cavity to room temperature and pressure; and removing the densified wood object from the cavity of the die.

In some aspects, the disclosure relates to a motorcraft, further including: a rotor made 1.

In some aspects, the disclosure relates to a motorcraft, further including four rotors having at least two blades.

In some aspects, the disclosure relates to a motorcraft, further including: a flight system configured to facilitate remote control; a camera coupled to a gimbal system; and a payload configured to activate.

In some aspects, the disclosure relates to a motorcraft, wherein the payload is an explosive.

In some aspects, the disclosure relates to an unmanned aerial vehicle (UAV), including: a frame; a plurality of prime movers coupled to the frame; a body panel coupled to the frame and made of a densified wood manufactured by: obtaining a wood sheet having a first specific strength; portioning the wood sheet into a plurality of wood blanks; bathing a wood blank of the plurality of wood blanks in a pretreatment liquid to reduce a lignin content of the wood blank; removing the wood blank from the pretreatment liquid; emplacing the wood blank in a cavity of a die; compressing and simultaneously heating the wood blank within the cavity of the die to: conform the wood blank into a shape of the cavity of the die, and simultaneously densify a cellular structure of the wood blank to create a densified wood object; maintaining a pressure and a temperature within the cavity above a threshold pressure and a threshold temperature for a period of time between approximately 0.5 hours to approximately 24 hours within the cavity; adjusting the temperature and pressure to dehydrate and reconsolidate the densified wood object within the cavity to room temperature and pressure; removing the densified wood object from the cavity of the die; a plurality of rotors coupled to the plurality of prime movers and made of the densified wood; a flight system configured for remote control of the plurality of prime movers; and a camera configured to provide a real-time video feed.

In some aspects, the disclosure relates to a UAV, further including four rotors having at least two blades.

In some aspects, the disclosure relates to a UAV, further including a payload configured to detonate.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a depiction of a tree trunk, according to some implementations;

FIG. 2 is a depiction of a lignocellulosic substrate, according to some implementations;

FIG. 3 is a depiction of a densified lignocellulosic substrate, according to some implementations;

FIG. 4 is a schematic diagram of a wood pretreating and densification system, according to an exemplary implementation;

FIG. 5 is a photo of a wood sheet and wood blanks, according to some implementations;

FIGS. 6-7 are detail views of wood blanks of FIG. 5, according to some implementations;

FIG. 8 is a cross-section view of an open die with a wood blank, according to some implementations;

FIG. 9 is a cross-section view of a closed die compressing the wood blank, according to some implementations;

FIG. 10 is a cross section of a densified wood object, according to some implementations;

FIG. 11 is a perspective view of a portion of an aircraft including a densified wood propeller, according to some implementations;

FIG. 12 is a top perspective view of unmanned aerial vehicles including densified wood rotors, according to some implementations;

FIG. 13 is a top perspective view of a rotor blade, according to some implementations;

FIG. 14 is a bottom perspective view of the rotor blade, according to some implementations;

FIG. 15 is a schematic diagram of a radar detection space and aircraft, according to some implementations;

FIG. 16 is a flow diagram of a process for manufacturing densified wood objects, according to some implementations;

FIG. 17 is a photograph of a 19.42 mm thick pine wood blank that is pre-treated, according to some implementations;

FIG. 18 is a photograph of the wood blank of FIG. 17 that is densified and has a thickness of 7.74 mm, according to some implementations;

FIG. 19 is a photograph of a 19.42 mm thick pine wood blank that is pre-treated, according to some implementations;

FIG. 20 is a photograph of the wood blank of FIG. 18 that is densified and has a thickness of 12.04 mm, according to some implementations;

FIG. 21 is a photograph of a 19.72 mm thick oak wood blank that is pre-treated, according to some implementations;

FIG. 22 is a photograph of the wood blank of FIG. 21 that is densified and has a thickness of 14.67 mm, according to some implementations;

FIG. 23 is a photograph of a 39.37 mm thick pine wood blank that is pre-treated, according to some implementations;

FIG. 24 is a photograph of the wood blank of FIG. 24 that is densified and has a thickness of 16.87 mm, according to some implementations;

FIG. 25 is a perspective view of a wood blank, according to some implementations;

FIG. 26 is a perspective view of the wood blank in a cavity of a die after being densified, according to some implementations;

FIG. 27 is another perspective view of the wood blank of FIG. 25 in the cavity of the die after being densified, according to some implementations;

FIG. 28 is a bottom perspective view of the densified wood object of plywood with a surface finish applied, according to some implementations; and

FIG. 29 is a top perspective view of the densified wood object of FIG. 28 with a trimmed rim and a surface finish applied, according to some implementations.

### DETAILED DESCRIPTION

Before turning to the figures, which illustrate the exemplary implementations in detail, it should be understood that the present application is not limited to the details or methodology set forth in the description or illustrated in the figures. It should also be understood that the terminology is for the purpose of description only. Like reference numerals in the figures may represent and refer to the same or similar element, feature, or function.

Referring generally to the FIGURES, wood is a multi-scale structured tissue of the stems and roots of woody plants. Wood is one of the most abundant, renewable, and sustainable natural resources on earth. Wood is a natural composite of cellulose fibers embedded in matrix of lignin, and exhibits characteristic material properties, such as rigidity, density, tensile strength, compressive strength, thermal resistivity, electrical resistivity, and sound deadening (absorbance, damping, attenuating). Wood products are typically manufactured via subtractive manufacturing processes including sawing, planing, drilling, machining, milling, routing, carving, and sanding.

To resist decay and rotting, wood can be treated by dehydrating the wood and/or adding chemical preservatives to the wood via impregnation techniques such as pressure treating. During pressure treating, wood is emplaced in a negative pressure environment inside a pressure chamber and chemical preservatives are introduced. Subsequently the pressure is reversed to a positive pressure which drives the preservatives deep into the cellular structure of the wood. The chemical preservation takes place when a chemical reaction occurs between the chemical preservative and the polymeric constituents of wood (e.g., lignin, hemicelluloses, cellulose), resulting in the formation of a stable covalent bond between the reagent of the preservative and the cell-wall polymers.

For example, a chemical preservation technique may be acetylation or furfurylation. Acetylation involves exposing wood to an acetylating agent (e.g., acetic anhydride, acetyl chloride, etc.) to form acetoxy groups and prevent the free hydroxyl groups (e.g., of lignin and hemicelluloses) from bonding with water molecules. Similarly, furfurylation involves exposing the wood to a furfuryl alcohol which subsequently undergoes a polycondensation reaction within the wood cell and polymerizes within the wood cell to prevent the free hydroxyl groups of lignin and hemicelluloses from bonding with water molecules. Furfurylation can involve heating the impregnated wood to encourage the furfuryl alcohol and resins of the lignocellulose to polymerize.

Another chemical impregnation technique includes impregnating the wood with a resin such as a phenol-formaldehyde (PF) resin to add dimensional stability, strength, hardness, and durability. As a nonlimiting and specific example, impregnating wood with 1.3-dimethylol-4.5-dihydroxyethyleneurea (DMDHEU) can improve the wood's durability and reduce its moisture uptake.

Another approach to enhancing resistance to wood decay and rotting includes thermal processing, including thermo-hydro (TH) processing and thermo-hydro-mechanical (THM) processing. Thermal processing (e.g., wood aging) involves exposing wood to temperatures between 100-150 degrees Celsius for a period of time to dehydrate the wood. TH processing involves exposing wood to heat and moisture. THM processing involves exposing the wood to heat, moisture, and a subsequent application of mechanical force. The thermal wood treatments often use temperatures between 100-300 degrees Celsius to soften the wood using steam or water to relieve internal stresses. To control wood degradation, temperatures between 150-260 degrees Celsius can be used to improve the wood's shape stability and also the wood's decay resistance. In THM processing, thermal treatment can be followed by compression in the axial or transverse direction of the wood to straighten or bend the wood. For example, to achieve curves and bends in a thin board or plank of wood, the board or plank can be exposed to steam and simultaneously bent into a curved shape. However, steam bending is not conducive to tight and/or complex bends due to large deformation gradients and strains that fracture the wood.

Carving is a common method to fabricate complicated wood parts. However, carving can be burdensome and time consuming. Thus, there is a need to develop a fast and easy wood manufacturing process to fabricate 3D wood parts.

The systems and methods described herein provide solutions to these and other technical problems described herein through a wood molding and sheet forming system and method that plastically deform wood into a complex shape with heat and compression molding that produce enhanced mechanical properties of the wood material simultaneously. The systems and methods described herein can provide a user the flexibility to fabricate objects (e.g., jewelry, engineering parts, machines, spoons, coasters, logo, coin, etc.) that are made of renewable, eco-friendly (biodegradable, non-toxic, etc.) materials that have a high strength, a high thermal resistivity, a high electrical resistivity, a low cost, and which are useful in scientific and engineering applications. The systems and methods described herein provide a user the flexibility to efficiently manufacture complex wood objects from softwood, hardwood, and/or plywood, while yielding improvements in material properties such as Young's modulus, hardness, density, and impact resistance of the wood. The densified wood objects can be widely used and provide a viable alternative to non-degradable plastics, which may make the world more renewable and sustainable. In some implementations, the techniques include pretreatment of a natural wood bulk such as wood or plywood; heating the wood/plywood to a glass transition temperature; conform the wood/plywood into shape in dies with mechanical compression and/or vacuum processing; controlling the temperature under desired pressure until wood is reconsolidated; cooling the wood to room temperature; and removing the deformed wood plate from the dies. The strength, Young's modulus, radar signature, and density of the produced parts are adjustable based on the variety of the wood, cellulose content in the wood, and the compressing and vacuum processing.

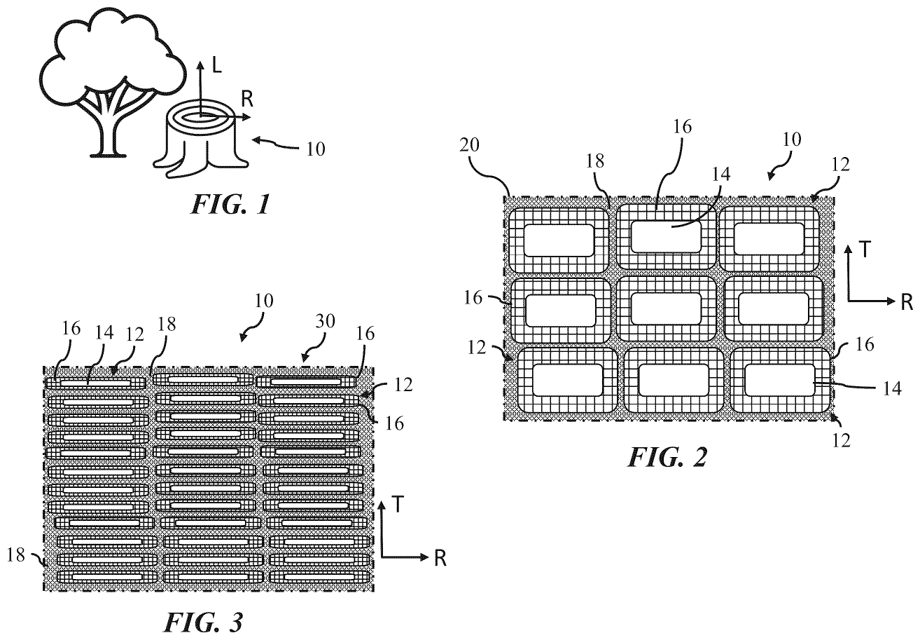

Referring to FIG. 1, a cross-section of a lignocellulosic substrate or tree trunk 10 is shown to extend longitudinally along a longitudinal axis L and in a radial direction along a radial axis R. FIG. 2 illustrates a cross-section of a microstructure 20 of the lignocellulosic substrate or wood of the tree trunk 10. The microstructure 20 includes long wood cells 12 defining a lumen 14 and a lignocellulosic cell wall 16. The microstructure 20 may include ray cells or thin cells that extend primarily in the radial direction R and tangential direction T. The lignocellulosic cell wall 16 has a primary layer and a secondary layer, and the secondary layer includes a first secondary layer (S1 layer), a second secondary layer (S2 layer), and a third secondary layer (S3 layer). The long wood cells 12 are mostly aligned with the longitudinal axis L and are spaced and bound together by the middle lamella or compound middle lamella (CML) 18. The CML 18 is primarily composed of pectins and includes lignin and hemicelluloses. Overall, the primary lignocellulosic constituents of the wood microstructure 20 are cellulose (typically 40-50%), hemicellulose (typically 10-30%), and lignin (typically 20-30%, including lignin precursors). Cellulose is a homopolysaccharide of d-glucose monomers stabilized by hydrogen bonds. Linear chains of cellulose form an elementary fibril. Bundles of elementary fibrils coagulate and form microfibrils, which crystalize to form cellulose fibers. Hemicellulose is a partially crystalline polymer that surrounds the cellulose fibers and serves as a matrix or binder, and is typically composed of glucose and different pentoses (e.g., xylose, mannose, arabinose, etc.), depending on the wood species. Lignin is a polymer composed of monomers (e.g., sinapyl alcohol, coniferyl alcohol, and paracoumaryl alcohol) linked by carbon-carbon linkages and ether linkages, and acts as a matrix or binder for the cellulose fibers. Lignin is relatively hydrophobic compared to hemicellulose and is frequently in an amorphous form in lignocelluloses. The lignin covalently bonds with hemicellulose and contributes to the mechanical strength of the cell wall 16. The bulk of the mechanical strength in the cell wall 16 is attributable to cellulose and lignin.

Wood densification occurs when a wood bulk is compressed throughout its entire thickness to alter the lignocellulosic structure of the wood. During wood densification, cell walls 12 buckle and reduce the volume of the lumen 14. FIG. 3 illustrates a densified wood microstructure 30 where the wood cells 12 have compressed and the volumes of their lumen 14 are reduced or eliminated. Densification may be achieved by subjecting the wood bulk to compressive stress and heat. When the wood bulk is heated above its glass transition temperature (T_{g}), the carboxyl groups in the hemicellulose are destroyed, and ester linkages of carboxylic groups from lignin and hemicellulose are formed. The glass transition temperature of the wood varies depending on the composition of the wood. For example, the glass transition temperature can vary based on the moisture content, ionic concentration, and the species of wood. Hardwoods, for example, typically have a lower glass transition temperature than softwoods because softwoods typically contain more lignin (typical T_{g} between 50-100 degrees Celsius) and less hemicellulose (typical T_{g} of 40 degrees Celsius) than that of hardwoods. During the densification process, the wood bulk may be heated above the glass transition temperature of both lignin and hemicellulose, but below the glass transition temperature of cellulose (typical T_{g} greater than 100 degrees Celsius).

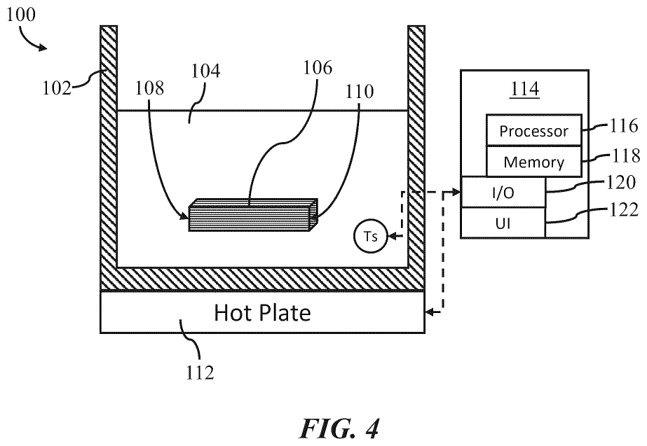

In some implementations, the wood is prepared for wood densification by reducing the lignin content of the wood bulk. Referring to FIGS. 4, 8 and 9, a system 100 is configured to manufacture densified wood objects. The system 100 may include a container 102 configured to contain a volume of a pretreatment liquid 104 within which a wood blank 106 may be at least partially submersed. The pretreatment liquid 104 is configured to soften the wood blank 106 and improve the workability and fracture-resistance of the wood blank 106. For example, the liquid 104 may be or include a lignin-modifying enzyme (e.g., oxidative enzymes such as peroxidases and laccase type phenoloxidases), an ionic liquid (e.g., a protic ionic liquid), a deep eutectic solvent, and/or an organisolv (e.g., an aromatic alcohol and/or aliphatic alcohol with an acidic catalyst). In some implementations, the liquid 104 may be or include at least one of sodium hydroxide (NaOH), sodium sulfide (Na₂S), sodium sulfite (Na₂SO₃), sodium chlorite (NaClO₂), hydrogen peroxide (H₂O₂), sodium hypochlorite (NaOCl), water (H₂O), and/or calcium hypochlorite (Ca(ClO)₂). In some implementations, the pretreatment liquid 104 may be a solution or a suspension that is in a liquid phase at STP. In some implementations, the chemical makeup of the pretreatment liquid, pressures, and temperatures are adapted based on the species of wood and the target performance properties of the densified wood object.

In some implementations, the wood blank 106 is exposed to the liquid 104 by steaming, soaking, and/or heating the wood blank 106 in one or more pretreatment liquids 104. For example, the wood blank 106 may be cycled through a sequence of chemical baths to achieve a target lignin content. In some implementations, after exposing the wood blank 106 to the pretreatment liquid(s) 104, the wood blank 106 may be rinsed or purged with water. For example, the pretreated wood blank 106 may be rinsed, steamed, bathed, etc. in water to remove the bulk of the pretreatment liquid 104 from the wood blank 106 such that the wood blank 106 is substantially free of the pretreatment liquid(s) 104. In some implementations, the pretreated wood blank 106 may be rinsed, steamed, bathed, etc. in a series of solutes to remove the bulk of the pretreatment liquid from the wood blank 106. In some implementations, after the wood blank 106 is exposed to the pretreatment liquids 104, the pretreated wood blank 106 is at least partially dehydrated. For example, the wood blank 106 may undergo natural air drying and/or convective drying. In some implementations, the pre-treatment parameters, such as steaming parameters (e.g., steam temperature, steam duration, etc.), chemical compositions and concentrations, soaking and cooking temperature and time, etc., can be adapted to account for varying geometric dimensions and composition of the wood blank 106 to promote efficient uniform exposure of the wood blank 106 to the pretreatment. For example, a thicker wood blank 106 may be exposed to a liquid at a lower temperature for a longer duration of time than a thinner wood blank 106.

In some implementations, the system 100 includes a heater 112 configured to heat the pretreatment liquid 104 to one or more temperature setpoints. In some implementations, the system 100 may include a controller 114 having a processing circuit having one or more processors 116 and one or more memory devices 118 storing instructions thereon that, when executed by the one or more processors 116, cause the controller 114 to perform one or more functions described herein. For example, the controller 114 may receive, via a communications circuit 120, a signal from a temperature sensor Tₛ regarding the temperature of the pretreatment liquid 104 and may selectively operate a heating element of the hot plate 112 to adjust the temperature of the pretreatment liquid 104. The controller 114 may display information regarding the operations 114 via a user interface 122. The user interface 122 may include one or more output devices (e.g., screens, speakers, etc.), and input devices (e.g., buttons, touch sensitive surfaces, microphones, cameras, etc.) configured to receive an input from a user. In some implementations, the user interface 122 may display an elapsed time, a temperature setpoint, a temperature value of the pretreatment liquid 104, and/or other information regarding the pretreatment liquid 104.

In some implementations, the communications circuit 120 facilitates communications between the controller 114, the heating element 112, actuator(s) of the die 150, an administrative computing device, a cloud platform, and/or the user interface 122. In some implementations, the communications circuit 120 is or includes wired or wireless communications interfaces (e.g., jacks, transmitters, receivers, antennas, transceivers, wire terminals, etc.). In some implementations, the controller 114 is implemented within a single computer (e.g., one housing, one chassis, etc.). In some implementations, the controller 114 is distributed across multiple servers, computers, or clusters.

In some implementations, the processor 116 can be implemented as a general purpose processor, one or more field programmable gate arrays (FPGAs), a group of processing components, an application specific integrated circuit (ASIC), or other suitable electronic processing components. In some implementations, the processor 116 is a or includes an advanced RISC machine (ARM) based processor.

In some implementations, the memory 118 can be or include one or more devices (e.g., RAM, ROM, Flash memory, eROM, SSD storage, HDD storage, etc.) for storing data and/or computer code, instructions, for completing or facilitating the various processes, layers and modules described herein. In some implementations, the memory 118 is or includes volatile memory or non-volatile memory. The memory 118 can include database components, object code components, script components, or other instruction structures for supporting the various activities, tasks, and information structures described herein. In some implementations, memory 118 is communicably connected to processor 116 via the processing circuit and includes computer code for executing (e.g., by the processing circuit and/or the processor 116) one or more processes described herein.

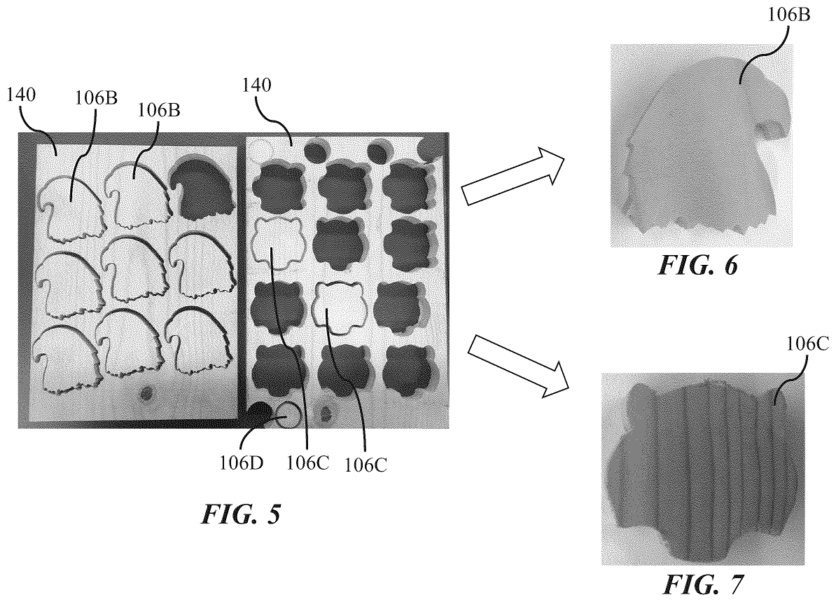

Referring to FIGS. 4-5, the wood blank 106 may be pre-shaped prior to being placed into the cavity 152 of the die 150, according to some implementations. For example, the wood blank 106 may be pre-shaped to have a profile similar to a profile of the cavity 152. For example, as illustrated in FIGS. 5-7, the wood blank 106 may be portioned into one or more of a bird-shaped wood blank 106B, a cat-shaped wood blank 106C, and/or a disk-shaped wood blank 106D. In some implementations, the wood blank 106 may be pre-shaped to facilitate localized deformations (e.g., embossing, debossing, texturing, patterning, etc.) on the surface of the wood blank 106. For example, enhancing the thickness and contour of the surface of the wood blank 106 prior to densification may increase the springback resistance of the densified wood object.

In some implementations, the thickness and surface contour of the wood blank 106 is adjusted during pretreatment to adjust the weight distribution of the wood blank 106 about a balance point. For example, if the densified wood object is a propeller (e.g., propeller 202), the wood blank 106 may be balanced to accommodate the natural variations in the wood density and structure and thereby contribute to a reduction in the vibrations generated by rotation of the propeller around the balance point.

Referring to FIG. 5-7, one or more bird-shaped wood blank 106B, a cat-shaped wood blank 106C, and/or a disk-shaped wood blank 106D may be cut from wood sheets 140. The wood sheet 140 may be natural wood or a plywood. Advantageously, the systems and methods described herein provide a user the flexibility to densify natural wood and plywood. By heating the plywood to a temperature below the decomposition temperature of the adhesive of the plywood, densification of the lignocellulosic components can be achieved while avoiding compromising the integrity of the adhesive (which may lead to delamination). For example, the plies of a plywood sheet are typically held together by wood adhesives such as a phenol-formaldehyde (PF) resin, a urea-formaldehyde (UF) resin, a polyvinyl acetate (PVA) resin, polyurethane (PUR) resin, a melamine-formaldehyde (MF) resin, or a polyepoxide (epoxy). The thermal resistance and solubility of the wood adhesive can influence the selection of a chemical composition, concentration, and thermal dosing regimen of the pretreatment liquid 104. For example, the composition of the pretreatment liquid 104 may be selected to avoid exposing a water-soluble wood adhesive (e.g., PVA resin) to water. Similarly, the temperature of the pretreatment liquid 104 may be selected to avoid exposing the plywood to temperatures in excess of the glass transition temperature of the adhesive (e.g., for PVA resin, approximately 85 degrees Celsius). In this way, the lignin content of the lignocellulosic constituents of the plywood can be adjusted without inducing delamination of the layers of the plywood sheet.

In some implementations, one or more layers of the plywood sheet are delaminated, the layers are densified into a thin sheet or ply, and the densified sheets or plies are combined or recombined into a plywood sheet via a fresh application of a wood adhesive between one or more densified sheets. In some implementations, the plies of the plywood sheet are densified into an arcuate shape and the shaped plies are combined into a shaped plywood sheet via a fresh application of a wood adhesive between the shaped plies. Advantageously, the densified plywood according to implementations of the present disclosure provide enhanced mechanical performance, as well as additional technical advantages described herein.

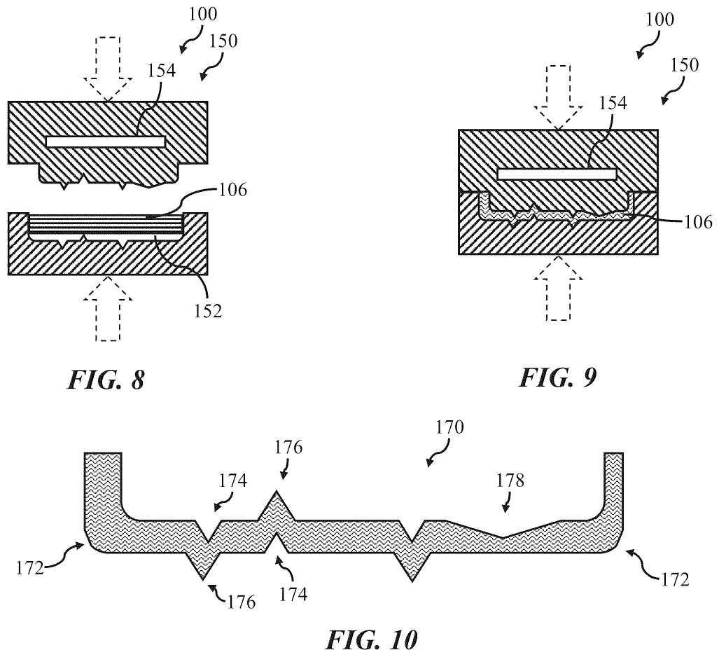

Referring to FIGS. 8-10, the system 100 includes a mold or die 150, according to some implementations. The die 150 defines a cavity 152 configured to receive the wood blank 106. In some implementations, the system 100 includes one or more actuators (e.g., hydraulic actuators) that are configured to drive the pieces of the die 150 together in the directions indicated by the dashed arrows. The die 150 is configured to compress the wood blank 106 into cavity 152 to conform the wood blank 106 into the shape of the cavity 152. The die 150 may include one or more heating elements 154 (e.g., resistive heating elements, heat exchangers, fluid passageways, etc.) configured to heat the material of the die 150 to a setpoint temperature. In some implementations, the heating elements 154 are operably coupled to the controller 114. In some implementations, the controller 114 is operably coupled with the actuators and controls the temperature and pressures exerted on the wood blank 106 within the cavity 152.

In some implementations, the wood blank 106 is a shape that is similar to a profile of the target densified wood object. For example, if the target densified wood object is a rectangular panel or an arcuate rectangular panel, the wood blank 106 may be a rectangular sheet. As another example, if the target densified wood object is a coin, circular bowl, or cylindrical cup, etc., the wood blank 106 may be a disk. As another example, if the target densified wood object is an elongate object (e.g., rod, link, strut, fork, knife, spoon, etc.), the wood blank 106 may be an elongate body that spans between a first end 108 and a second end 110 (see, e.g., FIG. 4). Referring to FIG. 10, the wood blank 106 has been transformed into a densified wood object 170 that has taken the shape of the cavity 152. The densified wood object 170 includes one or more bends 172, reliefs 174, ribs 176, and a dimple 178. The reliefs 174 (e.g., notches) may be jagged and sharp. The radius of the bends 172 may be smaller than the thickness of the material of the wood blank 106 at the bend 172. In some implementations, the bends 172 are 90-degree corners that define an edge or point.

Referring to FIG. 10, the material of the densified wood object 170 may exhibit a densification gradient across its volume. The densification gradient may reflect localized densification due to stress concentrations imparted by various features and points in the die 150. For example, if the wood blank 106 initially has a consistent thickness, the densification at the bottom of the dimple 178 may be greater than at the surrounding portions of the dimple 178.

In some implementations, the pretreatment process is adjusted based on the type of wood and/or a peak densification that achieves one or more performance characteristics of the densified wood product. The densification of the wood is approximately proportional to the increase in the strength for densifications of wood within a range of approximately 101%-500% densification. The peak densification may be localized to one or more portions of the wood blank 106. For example, half of the wood blank 106 may be densified to 200% while the other half may be densified to a value different than 200%, or not densified.

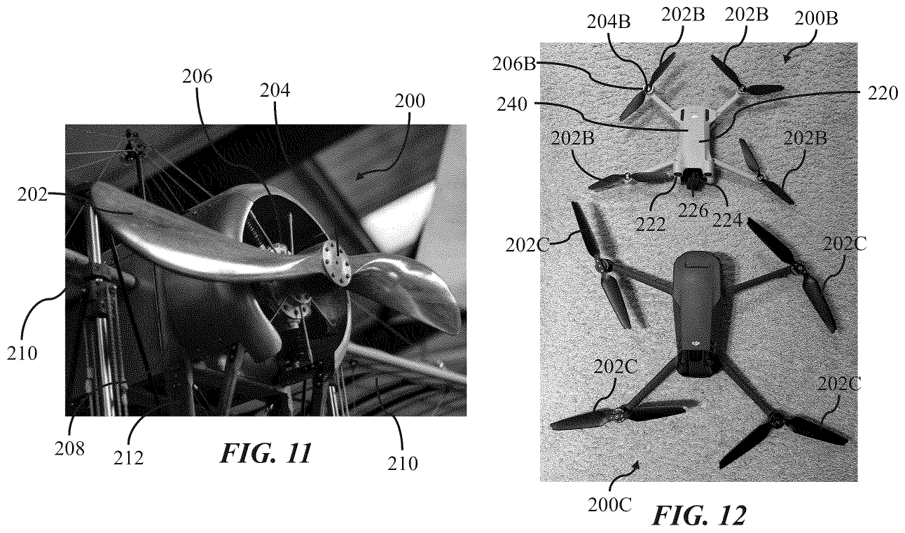

Referring to FIGS. 11-14, the densified wood object is a propeller 202 of an aircraft 200 (e.g., airplane, helicopter, quadcopter, unmanned aerial vehicle, etc.), according to some implementations. The densified wood of the propeller 202 provides an improved specific strength compared to that of a natural wood bulk while having a lower dielectric constant than metals and natural wood bulk. The low dielectric constant of the densified wood according to the present disclosure reduces the radar signature of the aircraft 200 and UAV 200B, which reduces the likelihood of adverse countermeasures being deployed against the aircraft 200 and UAV 200B, and thereby improves the efficiency and effectiveness of the aircraft 200 and UAV 200B. Moreover, the high specific strength of the densified wood is less costly than other high specific strength materials such as carbon fiber and titanium, which, in disposable or self-destructive systems and devices, for example, can provide appreciable cost savings. The aircraft 200 may include a propeller 202 that may be coupled to an output shaft 204 of a prime mover 206 (e.g., electric motor, internal combustion motor, etc.). The prime mover 206 may be fixedly coupled to a frame 208 and operably coupled to an energy storage device (e.g., battery, hydrogen fuel cell, gas tank, etc.). When the prime mover 206 drives the propeller 202 to rotate about an axis of rotation of the output shaft 204, the propeller 202 can generate thrust which can propel the aircraft 200. In some implementations, the aircraft 200 includes one or more wings 210 configured to generate lift when air passes over the surfaces of the wings 210. For example, the wings 210 may be an airfoil shape. In some implementations, the aircraft 200 includes control surfaces such as elevators, rudders, ailerons, etc. The aircraft 200 may also include landing gear 212 and wheels, which may be fixed in a deployed position and/or selectively retractable into a stowed position.

Referring to FIG. 12, in some implementations the aircraft 200 is an unmanned aerial vehicle 200B including a plurality of propellers or rotors 202B (e.g., rotary wings) formed from densified wood as described herein. The propellers or rotors 202B can be coupled to output shafts 204B of brushless DC motors 206B. In FIG. 12, the UAV 200B includes four rotors in a quadcopter configuration. In some implementations, the UAV 200B may include more than four rotors (e.g., five, six, seven, eight, nine, ten, eleven, twelve, twenty, etc.), or fewer than four rotors (e.g., one, two, three). In some implementations, the UAV 200B includes a combination of propellers and rotors 202B. In some implementations, the rotors 202B may be selectively rotated relative to the frame 208B to adjust the direction of thrust from the rotors 202B. For example, the rotors 202B may produce vertical or angled thrust, and may be rotated to provide forward thrust in a direction parallel to the direction of forward travel.

In some implementations, the UAV 200B includes a flight system 220 including one or more processors and one or more memory devices configured to drive the motors 206B to rotate the rotors 202B. The flight system may include one or more flight sensors 222 (e.g., accelerometers, barometers, temperature sensors, airspeed sensors, obstacle avoidance sensors, global positioning system transponders, etc.). The sensors 222 may facilitate collision avoidance, remote control, and smart flight features (e.g., autonomous flight, subject tracking modes, point of interest modes, waypoint planning modes, return to home modes, etc.). The flight system 220 may include one or more camera 224, which may be fixedly mounted or may be mounted on a gimbal system 226. The camera 224 may be or include an infrared camera (e.g., thermal imaging camera) and/or night vision camera (e.g., analog night vision, digital night vision, etc.).

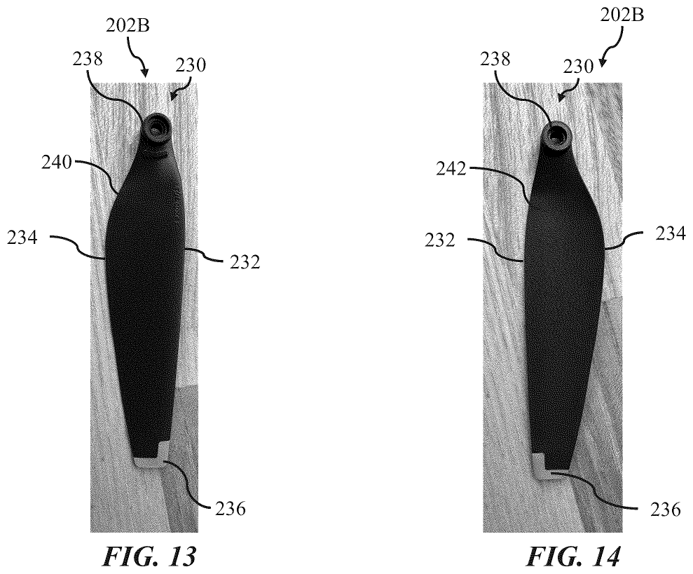

Referring to FIGS. 13-14, a rotor blade 230 of the rotor 202B is an airfoil shape having a leading edge 232, a tailing edge 234, a tip portion 236, a hub portion 238, a top surface 240, and a bottom surface 242. In some implementations, the hub portion 238 is pivotably coupled to the output shaft 204B of the motor 206B via a fastener such as a screw. Referring to FIGS. 8-9 and 13-14, in some implementations, the shape of the space defined by the cavity 152 may be the same as or substantially similar to the shape of the rotor blade 230. Advantageously, the densified wood rotor blade 230 provides enhanced mechanical performance similar to or exceeding that of metals such as aluminum, brass, and titanium, while providing an environmentally friendly, low cost, liquid that can improve the flight time and payload capacity of the UAV 200B.

In some implementations, the UAV 200B may include a payload 250. The payload 250 may be fixedly coupled to the frame 208B. In some implementations, the payload 250 is or includes equipment (e.g., clothing, batteries, munitions, etc.). In other implementations, the payload 250 is a tactical agent such as an explosive agent, a smoke emitting agent, a bio-agent, a radioactive agent, an electromagnetic-pulse emitting device, a jammer, or combinations thereof. The payload 250 may be lethal or less-lethal. In some implementations, the payload 250 is configured to activate or detonate upon impact with a target (e.g., a contact fuse, an inertia fuse, etc.). In other implementations, the payload 250 is configured to activate or detonate based on a time delay fuse (e.g., timed fuse), and/or based on a determination of being in a close proximity to a target (e.g., a proximity detonator, an altitude detonator, etc.). In some implementations, the payload 250 may be delivered by the UAV 200B to a target and subsequently activated or detonated to incapacitate a vehicle, enemy infrastructure, enemy personnel, and/or enemy equipment. In some implementations, the UAV 200B is a disposable or self-destructive payload delivery system and the payload 250 renders the UAV 200B inoperable upon activation or detonation of the payload 250. Advantageously, the high specific strength of the densified wood is less costly than other high specific strength materials such as carbon fiber and titanium, which, in disposable or self-destructive payload delivery systems, for example, can provide appreciable cost savings. In some implementations, the UAV 200B is configured to deploy a plurality of payloads 250. For example, the UAV 200B may include a payload delivery system configured to release a payload 250 and enable the UAV 200B to survive the activation or detonation of the payload 250. For example, the payload delivery system may drop the payload and enable the UAV 200B to be distanced from the payload 250 prior to activation or detonation of the payload 250 which may permit the UAV 200B to survive the activation or detonation of the payload 250.

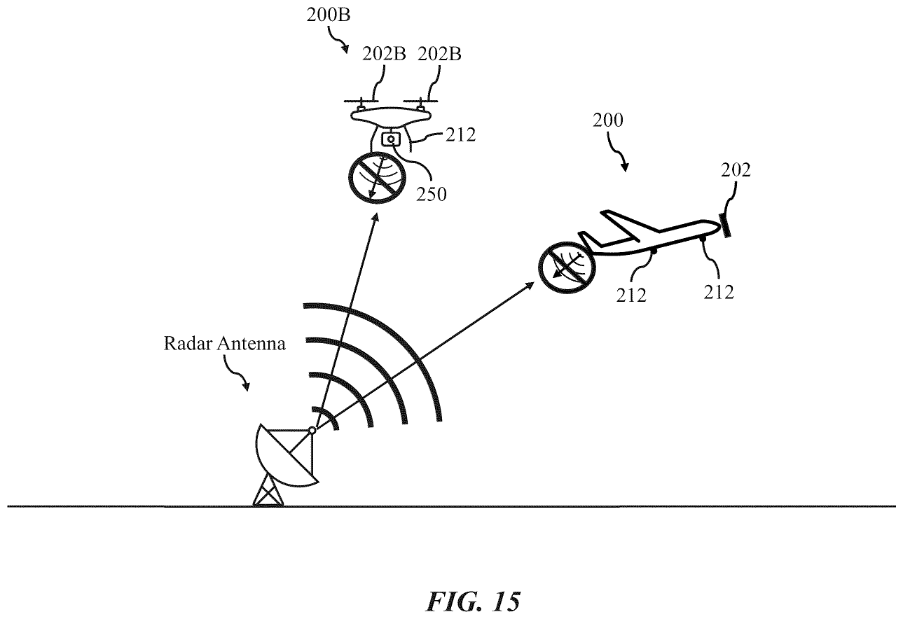

Referring to FIG. 15, the aircraft 200 and UAV 200B are configured for covert operations. The densified wood of the aircraft 200 and UAV 200B (e.g., rotor blades 230, propeller 202, frame 208, wings 210, and landing gear 212) provide an improved specific strength compared to that of a natural wood bulk while having a lower dielectric constant than metals and natural wood bulk. The low dielectric constant of the densified wood according to the present disclosure reduces the radar signature of the aircraft 200 and UAV 200B, which reduces the likelihood of adverse countermeasures being deployed against the aircraft 200 and UAV 200B, and thereby improves the efficiency and effectiveness of the aircraft 200 and UAV 200B. Moreover, the high specific strength of the densified wood is less costly than other high specific strength materials such as carbon fiber and titanium, which, in disposable or self-destructive payload delivery systems for example, can provide appreciable cost savings. In some implementations, the radar signature is calculated according to Equation 1 below:

$$σ = {lim}_{r \to ∞} 4 π {r}^{2} ( \frac{{S}_{s}}{{S}_{i}} ) \qquad [ 1 ]$$

Where r is the distance between the radar emitter to the object, Sₗ is the incident power density at the object, and Sₛ is the scattered power density seen at distance r. In some implementations, the rotors 202B and rotors 202C include winglets at the tip portion 236 and reduce the noise of the rotors 202B to reduce the sound signature of the UAV 200B which can reduce the detectability of the UAV 200B.

In some implementations, the densified wood object is coated in a water-resistant finish to prevent the densified wood from rehydrating after densification. For example, the rotor blade 230 may be coated in a polyurethane based paint or sealant, which may enhance the surface texture, reflectivity, and appearance (e.g., coloration) of the densified wood object. For example, in FIG. 11, the propeller 202 includes a glossy polyurethane-based coating. As another example, in FIGS. 12-15, the rotors 202B have a dark appearance which may reduce detectability during nighttime operations. In some implementations, the densified wood objects (e.g., rotors 202B) have a blue or blue-grey visual appearance that is visually similar to the color of a blue sky and/or clouds which may reduce visual detectability during daytime operations. In some implementations, the frame of the UAV 200B includes features that mimic a flying animal such as a soaring bird, which may conceal the identity of the UAV 200B and reduce the minimum visual identification distance within the detection range.

In some implementations, the densified wood object is an exterior panel or shell of the aircraft 200. Advantageously, the improved specific strength and durability of the densified wood can meet the demands of supersonic flight, while reducing the radar signature of the object.

In some implementations, the densified wood object is a component of a watercraft (e.g., boat, submarine, Bouey, mine, naval mine, torpedo, etc.). For example, the densified wood object may be or include one or more blades of a boat or submarine propeller, a frame, a hull, a keel, a rudder, stern plane, etc. Advantageously and unexpectedly, the densified wood reduces the sonar signature and detectability of watercraft. The sound deadening and low reflectance of the densified wood can attenuate the illuminating signal and can obscure the identity of the watercraft.

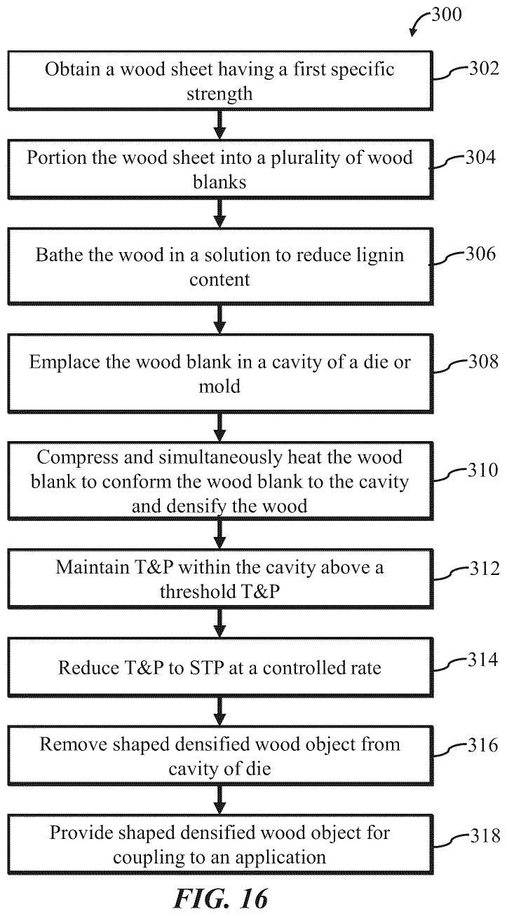

Referring to FIG. 16, a process 300 for manufacturing a wood object is shown, according to an exemplary implementation. The process 300 can be performed using the system 100 and the controller 114. In some implementations, the process 300 begins with a step 302.

In step 302, the process 300 includes obtaining a wood sheet having a first strength, according to some implementations. For example, the wood sheet 140 may be pine having a tensile strength of 49.2 megapascals (MPa). In other implementations, the wood sheet 140 may be oak (e.g., Quercus robur) having a tensile strength of 77.2 MPa, Douglas Fir (e.g., Pseudotsuga menziessii) having a tensile strength of 100 MPa, Maple having a tensile strength of 108.9 MPa, or walnut (e.g., Juglans nigra) having a tensile strength of 0.14 MPa. In some implementations, the wood sheet 140 is a plywood. The plywood may be a plywood with the wood grain rotated approximately 90 degrees in adjacent layers. The plywood may be constructed with at least three layers of wood that are held together using a wood adhesive. The outermost layers (the “back” and the “face”), and the interstitial layer(s) between the face and back (the “core”) can be made from either softwoods (e.g., cedar, pine, redwood, and spruce, Douglas fir, etc.) or hardwoods (e.g., oak, mahogany, teak, maple, ash, etc.) or a mix of softwoods and hardwoods. In some implementations, the wood sheet 140 is a composite plywood and the core is made of oriented strand board (OSB) or particle board.

In some implementations, step 302 includes log selection, log debarking, log cutting, peeling the logs into veneers, grading/sizing, gluing the veneers together, pressing the veneers in a hot press to cure the adhesive between the layers, and/or finishing (e.g., sanding, trimming, quality control). In some implementations, hot pressing compresses the boards under pressure (e.g., 110-200 psi), and temperature (e.g., 230-315 degrees Fahrenheit), for a period ranging from 2 to 7 minutes, ensuring contact between the veneers and adhesive. In some implementations, the plywood may be pressed into flat sheets. In some implementations, the process 300 continues with a step 304.

In step 304, the process 300 includes portioning the wood sheet into a plurality of wood blanks, according to some implementations. For example, the wood blank 106 may be pre-shaped as one or more bird-shaped wood blank 106B, a cat-shaped wood blank 106C, and/or a disk-shaped wood blank 106D. For example, enhancing the thickness and contour of the surface of the wood blank 106 prior to densification may enhance the springback resistance of the densified wood object. In some implementations, the thickness and surface contour of the wood blank 106 is adjusted during pretreatment to adjust the weight distribution of the wood blank 106 about a balance point. For example, if the densified wood object is a propeller (e.g., propeller 202), the wood blank 106 may be balanced to accommodate the natural variations in the wood structure and thereby contribute to a reduction in the vibrations produced by rotation of the propeller about the balance point. In some implementations, the process 300 continues with a step 306.

In step 306, the process 300 includes bathing a wood blank 106 in a pretreatment liquid 104 to reduce a lignin content of the wood blank, according to some implementations. In some implementations, bathing includes streaming the pretreatment liquid 104 continuously over the wood blank 106. For example, the pretreatment liquid 104 may be or include a lignin-modifying enzyme (e.g., oxidative enzymes such as peroxadases and laccase type phenoloxidases), an ionic liquid (e.g., a protic ionic liquid), a deep eutectic solvent, and/or an organisolv (e.g., an aromatic alcohol and/or aliphatic alcohol with an acidic catalyst). In some implementations, the pretreatment liquid 104 may be water. In some implementations, the pretreatment liquid 104 may be or include at least one of sodium hydroxide (NaOH), sodium sulfide (Na₂S), sodium sulfite (Na₂SO₃), sodium chlorite (NaClO₂), hydrogen peroxide (H₂O₂), sodium hypochlorite (NaOCl), and/or calcium hypochlorite (Ca(ClO)₂), and may be adapted based on the species of wood and the target performance properties of the densified wood object. The pretreatment liquid 104 is configured to soften the wood blank 106 and improve the workability and fracture-resistance of the wood blank 106. In some implementations, the wood sheet 140, or the wood blank 106 is placed in the container 102 pretreatment liquid 104. In some implementations, after exposing the wood blank 106 to the pretreatment liquid(s) 104, the wood blank 106 may be rinsed or purged with water. For example, the pretreated wood blank 106 may be rinsed, steamed, bathed, etc. in water to remove the bulk of the pretreatment liquid 104 from the wood blank 106 such that the wood blank 106 is substantially free of the pretreatment liquid(s) 104. In some implementations, the pretreated wood blank 106 may be rinsed, steamed, bathed, etc. in a series of solvents to remove the bulk of the pretreatment liquid from the wood blank 106. In some implementations, after the wood blank 106 is exposed to the pretreatment liquids 104, the pretreated wood blank 106 is at least partially dehydrated. For example, the wood blank 106 may undergo natural air drying and/or convective drying. In some implementations, the process 300 continues with a step 308.

In step 308, the process 300 includes emplacing the wood blank 106 in a cavity of a die 150, according to some implementations. For example, the wood blank 106 may be placed in the cavity 152 of die 150. In some implementations, the wood blank 106 undergoes the steps 302, 304, 306 within the cavity 152, and step 308 involves draining and/or rinsing the cavity 152 to remove the pretreatment liquid 104 from the cavity 152. In some implementations, the controller 114 may actuate an actuatable valve to permit the pretreatment liquid 104 to exit the cavity 152 of the die 150. In some implementations, the process 300 continues with a step 310.

In step 310, the process 300 includes compressing and heating the wood blank 106 within the cavity 152 of the die 150 to conform the wood blank 106 into the shape of the cavity 152 of the die 150 and simultaneously densify and remodel the cellular structure of the wood blank 106, according to some implementations. In some examples, the wood blank 106 is simultaneously compressed and heated within the cavity 152 of the die 150. In further examples, the wood blank 106 is compressed and heated within the cavity 152 of the die 150 sequentially. In some implementations, the controller 114 may actuate one or more actuators to drive the pieces of the die 150 together and compress the wood blank 106 into the shape of the cavity 152. In some implementations, the volume of the wood blank 106 is approximately 101% to 500% larger than the volume of the cavity 152. In some implementations, the process 300 continues with step 312.

In step 312, the process 300 includes maintaining a pressure and a temperature within the cavity 152 above a threshold pressure and a threshold temperature for a duration of time ranging from approximately 0.5 hours to approximately 24 hours to dehydrate and reconsolidate the shaped workpiece within the cavity 152 of the die 150, according to some implementations. For example, the threshold temperature may be a temperature above the glass transition temperature of lignin and hemicellulose but below the glass transition temperature of cellulose. For example, the temperature may range from 100 to 190 degrees Celsius. In some implementations, the threshold temperature may be a temperature above the glass transition temperature of lignin and hemicellulose but below the glass transition temperature of cellulose and the wood adhesive of the plywood sheet 140. For example, the temperature may range from 140 to 160 degrees Celsius. In some implementations, the threshold temperature is 110 degrees Celsius. In other implementations, the threshold temperature is 160 degrees Celsius. In some implementations, the process 300 continues with a step 314.

In step 314, the process 300 includes adjusting the temperature and pressure within the cavity 152 to room temperature and pressure, according to some implementations. For example, the temperature and pressure of the cavity 152 may be cooled to STP. In some implementations, the process 300 includes adjusting the temperature and pressure within the cavity 152 to room temperature and atmospheric pressure. In some implementations, the temperature is reduced at a constant rate (e.g., 10 degrees Celsius per hour) between the threshold temperature and STP or room temperature. The rates at which the temperature and pressure achieve STP or room temperature/atmospheric pressure may be continuous or discontinuous, linear or nonlinear, and/or proportional or nonproportional. In some implementations, the process 300 continues with a step 316.

In step 316, the process 300 includes removing the shaped workpiece from the cavity 152 of the die 150, according to some implementations. In some implementations, the die 150 may include an ejector. The ejector may be a pneumatic ejector. For example, the ejector may apply a burst of air into the interface between the cavity 152 and the densified wood object 170. In some implementations, the process 300 continues with step 318.

In step 318, the process 300 includes providing the shaped workpiece for coupling to a frame or drive shaft of an aircraft or a watercraft, according to some implementations. For example, the densified wood object may be a propeller 202, a rotor 202B and may be coupled to the prime mover 206 of the aircraft 200 or UAV 200B. In some implementations, the densified wood object may be a wood art, jewelry, coasters, logo, or coin. In some implementations, step 318 includes finishing the densified wood object by sanding, painting, and/or sealing. In some implementations, the process 300 concludes with a step 318.

### Test Data

Referring to FIG. 17, the wood pretreatment liquid 104 was made of 20 g of sodium hydroxide (NaOH) in 500 ml tap or fresh water. A pine wood plate (19.42 mm) was cut into an eagle shape 106B that corresponds to a profile of the cavity 152 of a die. The cut wood was sunk in the pretreatment liquid 104 and heated for approximately an hour at 90 degrees Celsius. The wood blank 106 then was rinsed with tap or fresh water until the sodium hydroxide and dissolved lignin were cleaned.

The pretreated wood blank was loaded in the die and heated to 110 degrees Celsius. The wood was then compressed into cavity of the die, and pressure was maintained as 7.0 MPa for approximately 20 minutes. Then the heating power was shut off, and the wood was held in the cavity of the die and the temperature of the wood piece dropped to room temperature. Then the densified wood part was removed from cavity of the die. Referring to FIG. 18, the thickness of the densified wood object was 7.74 mm.

Referring to FIG. 19, a 19.40 mm thick pine wood blank was soaked in water, and cooked for one hour at 90 degrees Celsius. The cooked wood blank was air dried in room temperature room over one day. Then the wood was cut into the profile shape to fit the size of the die.

The wood was loaded in the die and heated to 160 degrees Celsius. The wood was then compressed to fill the cavity of the mold, the pressure was maintained at 10.5 MPa for over 50 minutes. Then the heat power was shut off, and the wood piece remined in the die until the wood piece temperature dropped to room temperature. Then the wood part was removed from the cavity of the die. Referring to FIG. 20, the thickness of the densified wood object is 12.04 mm. Finishing was applied to the densified wood.

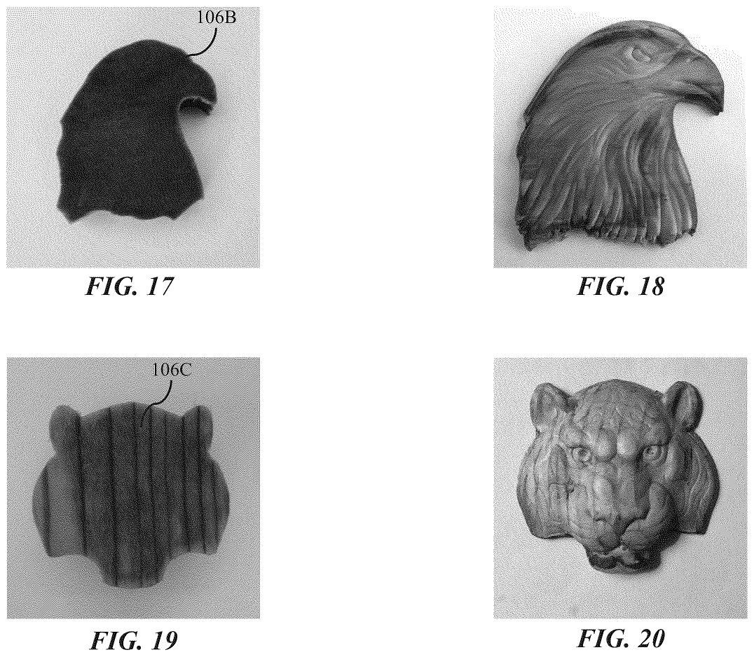

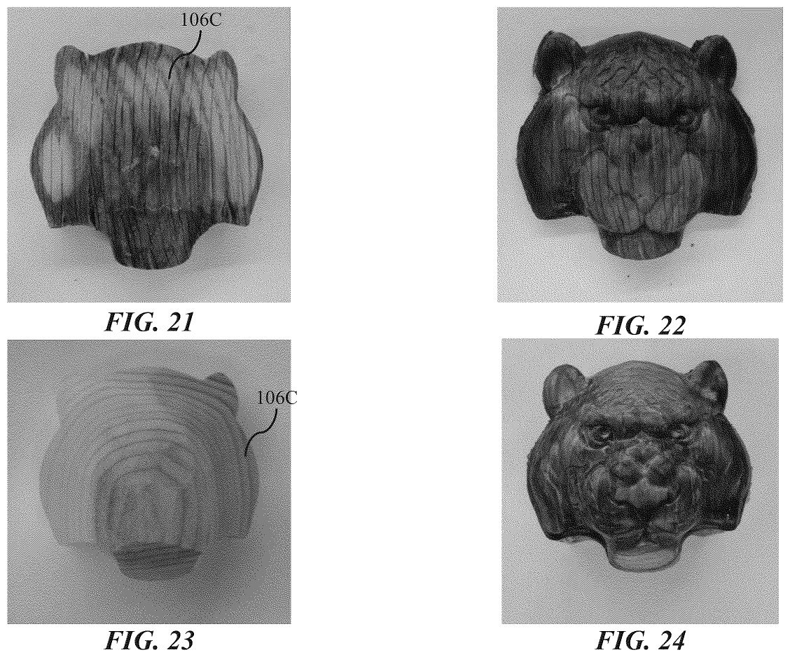

Referring to FIG. 21, pretreatment liquid was prepared by dissolving 20 g of NaOH in 500 ml tap or fresh water. A 19.47 mm thick oak plate was cut into shape to fit the profile of the die. The cut wood was sunk in the pretreatment liquid and cooked for over an hour at 90 degrees Celsius. Then the pretreated wood blank was rinsed with tap or fresh water until the sodium hydroxide and dissolved lignin were removed. Then the pretreated wood blank was dried at room temperature for three days. To facilitate a uniform deformation, the surface contour of pretreated oak wood blank was roughly shaped.

The wood blank was loaded and heated to 160 degrees Celsius in the die. Then the wood was compressed to fill into cavity in the die with maximum pressure of 28.02 MPa. Then the deformation of the molds was held constant for over 60 minutes, then the pressure dropped from 28.02 MPa to 14.01 MPa. Then the heating power was shut off, and let the wood staying in the mold until the temperature of the wood piece slowly dropped to room temperature. Then the wood part was removed from the die. Referring to FIG. 22, the thickness of the densified wood part is 14.67 mm.

Referring to FIG. 23, a 39.37 mm thick pine wood piece was cut into the profile shape to fit the size of the profile of the cavity of the die, and was soaked in water for two days. The wood blank was shaped to facilitate a uniform deformation during compression. Then the wood blank was air dried in room temperature for two days.

The wood blank was heated to 160 degrees Celsius in the die. The wood piece was compressed into the cavity in the die with pressure 28.0 MPa, and held in the die for one hour and 10 minutes while the pressure was incrementally reduced to 17.11 MPa. Then the wood piece was cooled to 60 degrees Celsius at a linear rate over three and a half hours. Then the temperature of the die was held at 60 degrees Celsius for ten hours and let the wood dehydrate and fully dry. Then the heating power was shut off, and the wood was kept in the die until the temperature of the wood piece dropped to room temperature (approximately 6 hours). Finally the densified wood piece was removed from die. Referring to FIG. 24, the thickness of the densified wood object was 16.87 mm.

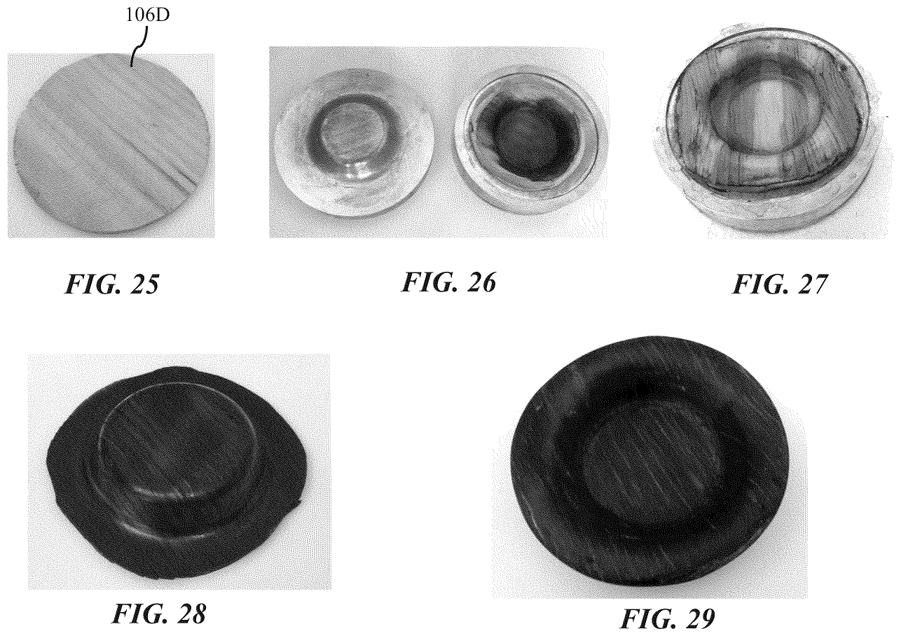

Referring to FIGS. 25-29, a densified wood bowl is fabricated from a disk-shaped wood blank 106D of a pine sheet of pine plywood. The wood became hard, harder than hard wood. The strength of the densified wood is greater than the strength of aluminum.

The tensile strength, specific tensile strength, Brinell hardness, density of the pine wood were measured and are tabulated in Table 1 and Table 2.

TABLE 1
Pine Wood Test Data and Oak Wood Test Data.

| | | | | | |
|---|---|---|---|---|---|
| | | Specific | | | |
| | Tensile | tensile | Yield | Average | |
| | strength | strength | Stress | Hardness | Density |
| Materials | (MPa) | (KN*m/Kg) | (MPa) | (HBN 10/100) | (Kg/m³) |

| | | | | |
|---|---|---|---|---|
| Pine wood | 49.2 | 97.5 | 2.29 | 5.04E2 |
| (Initial) | | | | |
| Pine wood | 158 | 131 | 8.59 | 1.20E3 |
| (Densified) | | | | |
| Oak | | | 4.59 | |
| (Initial) | | | | |
| Oak | | | 8.60 | |
| (Densified) | | | | |

TABLE 2
Reference values for Oak, Aluminum, Steel, and Copper materials.

| | | Specific | | | |
|---|---|---|---|---|---|
| | Tensile | tensile | Yield | Average | |
| | strength | strength | Stress | Hardness | Density |
| Materials | (MPa) | (KN*m/Kg) | (MPa) | (HBN 10/100) | (Kg/m³) |
| Red Oak | | | | 3.4-4.1 | |
| Pure | 90 | 33.5 | 30 | | |
| Aluminum | | | | | |
| 6061T6 | 310 | 115 | 240-276 | | 2.70E3 |
| Aluminum | | | | | |
| Low carbon | 330 | 42.3 | 210 | | 7.87E3 |
| steel 1006 | | | | | |
| Copper | 220 | 24.7 | 40-80 | | 8.93E3 |

Referring to Tables 1 and 2, the initial Brinell hardness of the tested sample of pine wood is 2.29 HBS10/100. Generally, the Brinell hardness HBS 10/100 (10 mm steel ball, 100 Kg load) of softwood and hardwood are 1.6 and 2.6-7.0 HBS 10/100 respectively. The average Brinell hardness of the densified pine wood tensile sample is 8.59 HBS10/100, which is much higher than its initial hardness and that of the tested red oak sample 4.98 HBS10/100.

Referring to Tables 1 and 2, the tensile strength of the densified pine wood sample is 158 MPa, which is three times higher than its initial tensile strength 49.2 MPa. The tensile strength of the densified pine wood sample is much higher than that of pure aluminum 90 MPa, but lower than that of low carbon steel (1006), 330 MPa, and Aluminum alloy 6061T6, 310 MPa. To increase the tensile strength of the densified pine wood sample, the pretreatment process can remove additional lignin content, and the orientation of the wood fiber can be adjusted relative to direction of the compressive forces.

Referring to Tables 1 and 2, the specific tensile strength of the densified pine wood is 131 KN*m/Kg, which is much higher than that of pure aluminum, 33.5 KN*m/Kg, and low carbon steel (1006), 42.3 KN*m/Kg, also is also higher than Aluminum alloy 6061T6, 115 KN*m/Kg.

In some implementations, the densification process makes the wood more dense and thinner. In some implementations, the process 300 increases the strength (e.g., tensile strength, specific strength) of pinewood to be higher than aluminum. The specific strength of the material is the strength of the material divided by the density of the material. In some implementations, Pinewood goes from having a specific strength of pinewood to a specific strength approximately four times that of aluminum. In some implementations, the wood can be densified achieve a strength that is approximately equal to three time that of steel. In some implementations, the wood is stamped, which increases the density of the wood. In some implementations, the pinewood can be densified achieve a hardness that is approximately twice of red oak.

In some implementations, a wood manufacturing processes includes 1) pretreating wood to become soft and potentially deformable under a thermodynamics status of next steps; 2) heating and compressing the pretreated wood, and bringing the wood piece into an appropriate plastically deformable thermodynamics status; 3) compressing and plastically deforming in the cavity of molds to form desired shapes; 4) controlling temperature and pressure until deformed wood is reconsolidated and dried; 5) cooling the wood to room temperature, and remove the produced wood part out of the molds. The mechanical properties of the produced wood parts are dependent on various types of wood, orientation of wood grain structures, moisture and cellulose content in the pretreated wood, mold shape, molding method, and parameters of the manufacturing process, such as, pressure, temperature and time. The technology could be utilized to fabricate wood arts, wood jewelry, high strength wood parts for a wide range of engineering and scientific applications, as well as daily live used products. The produced wood parts are environmentally friendly, renewable, and sustainable, high strength, high thermal and electrical insulation.

In some implementations, a processes of wood molding includes: a) pretreating wood to be plastically deformable materials with pretreatment liquids; b) shaping the wood sample if necessary, c) compressing and heating the wood into a required thermodynamics status and become soft and deformable, d) compressing the pretreated/pre-shaped wood in the cavity of a mold to plastically deform into desired shapes; e) controlling temperature and pressure under appropriated conditions until deformed wood is reconsolidated; f) cooling and drying the wood to room temperature in mold.

In some implementations, the pretreatment liquids comprises water, or lignin-modifying enzyme, or organosolv, or ionic liquids, or deep eutectic solvent, or water with sodium hydroxide (NaOH), and/or sodium sulfide (Na2S), and/or sodium sulfite (Na2SO3), and/or sodium chlorite (NaClO2), and/or hydrogen peroxide (H2O2), and/or sodium hypochlorite (NaOCl), and/or calcium hypochlorite (Ca(ClO)2), other chemicals which could remove lignin, and a combination thereof. In some implementations, the wood is steamed, or soaked in water or soaked in room temperature pretreatment liquids, or cooked in the hot pretreatment liquids. In some implementations, then the pretreated wood is rinsing with tap or fresh water or distilled water to remove the chemicals of pretreatments. Dry process may remove the extra water in the wood. In some implementations, pre-shaping wood sample may help to ensure a relatively uniform deformation gradient in the molding processing to gain all the detail designed features. In some implementations, the mold, and the pretreated wood are compressed and heated to desired temperature, to become soft and deformable. In some implementations, the soften wood is compressed and deformed to fill the cavity of the mold into a desired shape. In some implementations, time and thermodynamic state (temperature and pressure) of pretreated wood are controlled to reconsolidate the wood and form new multi-scale structured woods. In some implementations, the process includes then cooling and drying the processed wood to room temperature in mold, and remove the produced wood part out of the mold, and optional finishing.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as utilized herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary implementations, and that such variations are intended to be encompassed by the present disclosure.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, or microcontroller. A processor may also be implemented as a combination of computing devices, such as a combination of a DSP and a microprocessor, multiple microprocessors, one or more microprocessors in conjunction with a DSP core, or any other such configuration. In some implementations, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers, and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit or the processor) the one or more processes described herein.

The present disclosure contemplates methods, system and program products on any machine-readable media for accomplishing various operations. The implementations of the present disclosure may be implemented using existing computer processors, or by a special purpose computer processor for an appropriate system, incorporated for this or any other purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general purpose computer, special purpose computer, or special purpose processing machine to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

Values can be expressed herein as an “average” value. “Average” generally refers to the statistical mean value.

The term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

A volume percent (vol %) of a component, unless specifically stated to the contrary, is based on the total volume of the formulation or composition in which the component is included.

The expressions “ambient temperature”, and “room temperature” as used herein are understood in the art and refer generally to a temperature from about 20° C. to about 35° C. The expressions “ambient pressure”, and “room pressure” as used herein are understood in the art and refer generally to a pressure ranging from 0.8 atmosphere to 1.2 atmosphere. The term “standard temperature pressure” (STP), as used herein is understood in the art and refers to a temperature of 0° C. and a pressure of 1 bar.

The term “hydroxyl” as used herein is represented by the formula OH.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group.

The term “epoxy” or “epoxide” as used herein refers to a cyclic ether with a three atom ring and can represented by the formula:

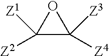

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group.

Unless otherwise defined, all technical and scientific terms used herein have the same meaning as commonly understood by one of ordinary skill in the art to which this invention belongs.

It is important to note that the construction and arrangement of the system 100 as shown in the various exemplary implementations is illustrative only. Additionally, any element disclosed in one implementation may be incorporated or utilized with any other implementation disclosed herein. Although only one example of an element from one implementation that can be incorporated or utilized in another implementation has been described above, it should be appreciated that other elements of the various implementations may be incorporated or utilized with any of the other implementations disclosed herein.

What is claimed is:

1. A method of manufacturing a densified wooden object, comprising:
bathing a wood blank in a pretreatment liquid to reduce a lignin content of the wood blank;
removing the wood blank from the pretreatment liquid;
rinsing the removed wood blank in fresh water;
emplacing the wood blank in a cavity of a die;
heating and compressing the wood blank within the cavity of the die to:
conform the wood blank into a shape of the cavity of the die, and
densify a cellular structure of the wood blank to create a densified wood object;
maintaining a pressure and a temperature within the cavity above a threshold pressure and a threshold temperature for a period of time within the cavity;
adjusting the temperature and pressure within the cavity to room temperature and pressure to dehydrate and reconsolidate the densified wood object;
removing the densified wood object from the cavity of the die; and
providing the densified wood object.

2. The method of claim 1, wherein the wood blank is one of a plurality of wood blanks formed by portioning a wood sheet, wherein the wood sheet has a first tensile strength, and wherein the tensile strength of the densified wood object is at least two times the first tensile strength.

3. The method of claim 1, wherein the pretreatment liquid includes at least one of a lignin-modifying enzyme, an ionic liquid, or an organisolv.

4. The method of claim 1, wherein the pretreatment liquid includes at least one of sodium hydroxide (NaOH), sodium sulfide (Na₂S), sodium sulfite (Na₂SO₃), sodium chlorite (NaClO₂), hydrogen peroxide (H₂O₂), sodium hypochlorite (NaOCl), and/or calcium hypochlorite (Ca(ClO)₂), or a combination thereof.

5. The method of claim 1, wherein the pretreatment liquid is room temperature or heated to a temperature between 50 degrees Celsius to 110 degrees Celsius.

6. The method of claim 1, wherein the threshold temperature is between 100 degrees Celsius and 190 degrees Celsius, and the period of time ranges from 0.5 hours to 24 hours.

7. The method of claim 1, wherein the wood object is plywood.

8. The method of claim 1, wherein the densified wood object is provided for coupling to an aircraft or a watercraft, and wherein the aircraft is an unmanned aerial vehicle.

9. The method of claim 1, wherein the densified wood object is a propeller or rotor.

10. The method of claim 1, wherein the densified wood object is a wood art, jewelry, spoons, coaster, logo or coin.

11. The method of claim 1, wherein compressing and simultaneously heating the wood blank within the cavity of the die includes applying a pressure of between 5 MPa to 60 MPa.

12. The method of claim 1, wherein the threshold pressure is 5 MPa.

13. The method of claim 1, wherein a tensile strength of the densified wood object is greater than 100 MPa.

14. A motorcraft comprising:
a prime mover including an output shaft; and
a propeller coupled to the output shaft and made of a densified wood manufactured by:
obtaining a wood sheet having a first tensile strength;
portioning the wood sheet into a plurality of wood blanks;
bathing a wood blank of the plurality of wood blanks in a pretreatment liquid to reduce a lignin content of the wood blank;
removing the wood blank from the pretreatment liquid;
emplacing the wood blank in a cavity of a die;
compressing and simultaneously heating the wood blank within the cavity of the die to:
conform the wood blank into a shape of the cavity of the die, and
simultaneously densify a cellular structure of the wood blank to create a densified wood object;
maintaining a pressure and a temperature within the cavity above a threshold pressure and a threshold temperature for a period of time between approximately 0.5 hours to approximately 24 hours to dehydrate and reconsolidate the densified wood object within the cavity;
adjusting the temperature and pressure within the cavity to room temperature and pressure; and
removing the densified wood object from the cavity of the die.

15. The motorcraft of claim 14, further comprising: a rotor made of a densified wood according to the method of claim 1.

16. The motorcraft of claim 14, further comprising four rotors having at least two blades.

17. The motorcraft of claim 14, further comprising:
a flight system configured to facilitate remote control;
a camera coupled to a gimbal system; and
a payload configured to activate.

18. The motorcraft of claim 17, wherein the payload is an explosive.

19. An unmanned aerial vehicle (UAV), comprising:
a frame;
a plurality of prime movers coupled to the frame;
a body panel coupled to the frame and made of a densified wood manufactured by:
obtaining a wood sheet having a first specific strength;
portioning the wood sheet into a plurality of wood blanks;
bathing a wood blank of the plurality of wood blanks in a pretreatment liquid to reduce a lignin content of the wood blank;
removing the wood blank from the pretreatment liquid;
emplacing the wood blank in a cavity of a die;
compressing and simultaneously heating the wood blank within the cavity of the die to:
conform the wood blank into a shape of the cavity of the die, and
simultaneously densify a cellular structure of the wood blank to create a densified wood object;
maintaining a pressure and a temperature within the cavity above a threshold pressure and a threshold temperature for a period of time between approximately 0.5 hours to approximately 24 hours within the cavity;
adjusting the temperature and pressure to dehydrate and reconsolidate the densified wood object within the cavity to room temperature and pressure;
removing the densified wood object from the cavity of the die;
a plurality of rotors coupled to the plurality of prime movers and made of the densified wood;
a flight system configured for remote control of the plurality of prime movers; and
a camera configured to provide a real-time video feed.

20. The UAV of claim 18, further comprising four rotors having at least two blades.

21. The UAV of claim 18, further comprising a payload configured to detonate.
